(19) United States
(12) Patent Application Publication
(10) Pub. No.: US 2011/0099591 A1
(43) Pub. Date: Apr. 28, 2011

(54) SECURE WIRELESS PAIRING OF DIGITAL TV SHORT-RANGE TRANSMITTER AND RECEIVER

(76) Inventors: Men Long, Hillsboro, OR (US); David M. Durham, Beaverton, OR (US)

(21) Appl. No.: 12/607,894

(22) Filed: Oct. 28, 2009

(51) Int. Cl. H04N 7/18; H04W 84/02; H04N 5/66; H04N 7/167; H04L 9/08

(52) U.S. Cl. 725/81; 370/338; 348/739; 380/239; 348/E05.133; 380/259; 380/282; 380/210

(57) ABSTRACT

Embodiments of wireless display of digital content include transmission using a television transmission standard, such as a set of standards defined by the Advanced Television Systems Committee (ATSC) for digital television (TV) transmissions. The digital content is transmitted in a short range wireless network. In some embodiments, an encryption technique is applied to add security allowing decryption by a digital television using a firmware update, allowing retrofitting of security to devices currently deployed.

### TECHNICAL FIELD

Some embodiments pertain to video communications and display. Some embodiments pertain to a wireless connection of a digital television.

### BACKGROUND

Digital content is provided in an increasing number of applications for a variety of devices. The ability to use digital content on multiple devices enhances the user's experience, creating demand for more content.

### BRIEF DESCRIPTION OF THE DRAWINGS

FIG. 1 illustrates a Wireless Local Area Network (WLAN), in accordance with example embodiments.

FIG. 2 illustrates a digital Audio/Video (AV) device and a computing device, in accordance with example embodiments.

FIGS. 3A, 3B, 4 and 5 illustrate an encryption mechanism for communications within a WLAN, such as in FIG. 1, in accordance with example embodiments.

FIG. 6 is a block diagram of a wireless network, in accordance with example embodiments.

FIG. 7 is a flow diagram illustrating a security method, in accordance with example embodiments.

FIG. 7 illustrates application of a security method to the blocks in a video frame, in accordance with example embodiments.

FIG. 8 is a flow diagram illustrating the security method applied to a video frame, as in FIG. 7, in accordance with example embodiments.

FIG. 9 is a flow diagram of an encryption method, in accordance with example embodiments.

### DETAILED DESCRIPTION

The following description and drawings sufficiently illustrate specific embodiments to enable those skilled in the art to practice embodiments. Other embodiments may incorporate structural, logical, electrical, process, and other changes. Examples merely typify possible variations. Individual components and functions are optional unless explicitly required, and the sequence of operations may vary. Portions and features of some embodiments may be included in, or substituted for, those of other embodiments. Embodiments set forth in the claims encompass all available equivalents of those claims. Embodiments may be referred to herein, individually or collectively, by the term “invention” merely for convenience and without intending to limit the scope of this application to any single invention or inventive concept if more than one is in fact disclosed.

Methods and arrangements for wireless communications in a local network, wherein digital content is transmitted among devices within the local network, are contemplated. Embodiments include transformations, code, state machines or other logic to provide a secure wireless pairing of a digital TV short-range wireless transmitter and receiver. In an example embodiment, digital video content is stored on a first device, which transmits the digital video content over the air using the wireless local network for performance on a display device. The display device is a digital television receiver having a screen adapted for such display and presentation. The digital television receiver operates on a standard protocol for receiving digital video content. The first device is capable of transmitting the digital video content for receipt and performance by the display device.

The embodiments may also include incorporating short-range digital transmitters into computing devices, wherein a unique security algorithm enables secure wireless display in a digital TV. While specific embodiments will be described below with reference to particular circuit or logic configurations, those of skill in the art will realize that embodiments of the present invention may advantageously be implemented with other substantially equivalent configurations.

In an example embodiment, a short-range transmitter, such as a transmitter supporting a set of standards defined by the Advanced Television Systems Committee (ATSC) for digital television (TV) transmissions, is incorporated into a Personal Computer (PC) or computing device. A short-range radio enables communications between two or more wireless devices in relatively close proximity. The PC may be a laptop or other computing device, such as a Mobile Internet. Device (MID) or other device having wireless capabilities to support data transmissions. The PC implements a unique security algorithm to enable secure wireless displays. The wireless display may be a television, or other display device, supporting wireless communications. The unique security algorithm may be used with existing and new mass market televisions, including High-Definition TVs (HDTVs). The wireless display may support a High-Definition Multimedia Interface (HDMI) type interface, which is a compact audio/video interface for transmitting uncompressed digital data, used with HDTVs.

According to some embodiment, a method is performed at a computing device to receive digital content and transmit the digital content to a display device. The display device may be a DTV, HDTV, and may include a set top box for receipt of television and other signals. The computing device is adapted to determine or generate a cryptographic key for encrypting raw data frames of the digital content. The encrypting may use a cryptographic key which is provided to a display device. The cryptographic key may be a session key or a secret key that is encrypted prior to transmission with a public key associated with the display device.

In some embodiments, the method includes establishing a wireless short range transmission channel with the display device, wherein the encrypted information is transmitted via the short range transmission channel. The short range transmission channel may support ATSC transmissions. The display device may include a DTV having an ATSC receiver, and the computing device may include an ATSC transmitter.

In some embodiments the cryptographic key is a symmetric cryptographic key. The computing device captures an image of a public key presented by the display device, such as an out-of-band display of the public key on the display device, or an audio signal output from the display device. The computing device is adapted to recognize and retrieve or accept the public key, which the computing device then uses to generate the cryptographic key. The computing device transmits encrypted frames of content data, such as frames of a movie, to the display device.

In some embodiments, the computing device performs a logical exclusive OR (XOR) operation to a block of raw data and a cryptographic key block to form an encrypted block of data. The display device is then adapted to perform a similar logical operation to retrieve the original digital content.

In an example embodiment, the display device receives an update packet of data including operations for enabling receipt of digital content from a computing device. The operations may include computer-readable code having instructions specifying operations to perform. The update packet then extends the functionality of the display device to enable receipt and display of content received from a computing device, such as via an ATSC transmission protocol.

In some embodiments, a display device may implement a method for receiving and displaying content, wherein the display device has a short-range ATSC receiver and the computing device includes an ATSC transmitter. The display device and the computing device establish a short range transmission channel by establishing an ATSC communication between the computing device and the display device. The display device receives a secret key from the computing device, the secret key encrypted with the public key and receives an encrypted frame of content at the ATSC receiver of the display device. The display device then decrypts the encrypted frame of content to retrieve the digital content for display at the display device. The decrypted content is presented for viewing by the display device.

In an example embodiment, the computing system includes a processing unit to control operations within the computing system an encryption unit to encrypt digital content using a cryptographic key, a transmitter to transmit encrypted digital content to a display device using an Advanced Television Systems Committee (ATSC) protocol, and a memory to store information related to the digital content and the cryptographic key.

In one embodiment, a display apparatus includes a receiver supporting a short range wireless communication protocol, a memory to store digital content and information for processing the digital content for display on the display apparatus, a decryption unit to apply a cryptographic key to encrypted digital content to transform the encrypted digital content into decrypted digital content, wherein the encrypted digital content is received at receiver, and a display controller to control display of the decrypted digital content. The display controller of the display apparatus is further to display a public key, wherein the receiver is further to receive a shared secret key from a computing device, the shared secret key encrypted with the public key, and wherein the shared secret key is used to generate the cryptographic key.

In an ATSC system signals are transmitted as cleartext, which are non-secure. The non-secure method enables instant wireless display capabilities to existing televisions from Intel platforms with this invention. In an example embodiment, a system retrofits a security method into an ATSC system simply using a firmware update. Using existing transmission techniques, in order to access content having such security mechanisms or to add security to a transmission a consumer may either replace an existing TV with a new wireless HDTV, or add hardware. Additional hardware may implement a piece of hardware that attaches to a computer to enable secured software, and is often referred to as a “dongle.” A dongle may be used as a high-end form of security to prevent unauthorized copies of software, code, content, and so forth, as it is more difficult to copy hardware than software. The additional hardware may implement Wireless Fidelity (WiFi), a wireless standard promulgated as IEEE 802.11, or other communications, which may be used for secure wireless displays.

In an existing DTV system, a radio receives wireless ATSC signals and feeds the demodulated signals to the customized MPEG2 decoder. Subsequently a microprocessor drives the video subsystem to display the decompressed video stream onto a TV screen.

In an example embodiment, a unique security algorithm enables a consumer to use an existing wireless display device to perform content having new or additional security extension without the need to purchase a new display device or hardware. Some embodiments may be based on existing standardized digital receivers. The security algorithm achieves the convenience and security of HD content playback from laptop computers, desktop computers, Ultra Mobile Personal Computing (UMPC) devices, MIDs, and so forth, as well as from existing full sized TV displays, such as legacy DTV/HDTV devices, wherein the content is provided via a wireless medium. Systems may implement a variety of wireless protocols for wireless communications, wherein the modulation, frequency band, signaling and processing are specific to the wireless protocol used. Each of these systems transmits the signal over the air from a transmitting computing device to a receiving DTV device according to the protocol used. In other words, each of the computing device and DTV support a same protocol. The security mechanism may be used for an Internet Access (IA)-based MID to allow secure use a full-sized TV display as the video output of the MID, thus freeing a viewer from working with the smaller LCD display integrated within the MID.

Users may plug in a peripheral card for a short-range ATSC transmitter in an existing computing device. The video content in the computing device is then broadcast in an encrypted form via an ATSC channel. A computing device with HD content as received from a server, such as through the Internet, or from a DVD or other storage medium, transmits the HD content wirelessly to a television or display device. Such method allows a simple firmware upgrade to the HDTV, and thus avoids the need to upgrade hardware in a TV, which effectively avoids the purchase a new TV. A TV proximate the transmitter may receive the broadcast content. In this way, the HDTV allows the firmware update to efficiently process the encrypted content, adding a security feature which is currently not part of terrestrial broadcasts. The security mechanism enables secure one-one bindings between an ATSC HDTV display and computing devices having a short range ATSC transmitter.

In some embodiments, a PC broadcasts secure content to ATSC receivers, wherein the security is backward compatible with DTVs and HDTVs, such as for TVs having an ATSC wireless interface. In the US, the readjustment of all UHF and VHF broadcast spectrum so as to support digital broadcasts requires legacy TVs to add ATSC tuners. This will result in an increase in the number of TV sets having ATSC receivers.

### A Wireless System

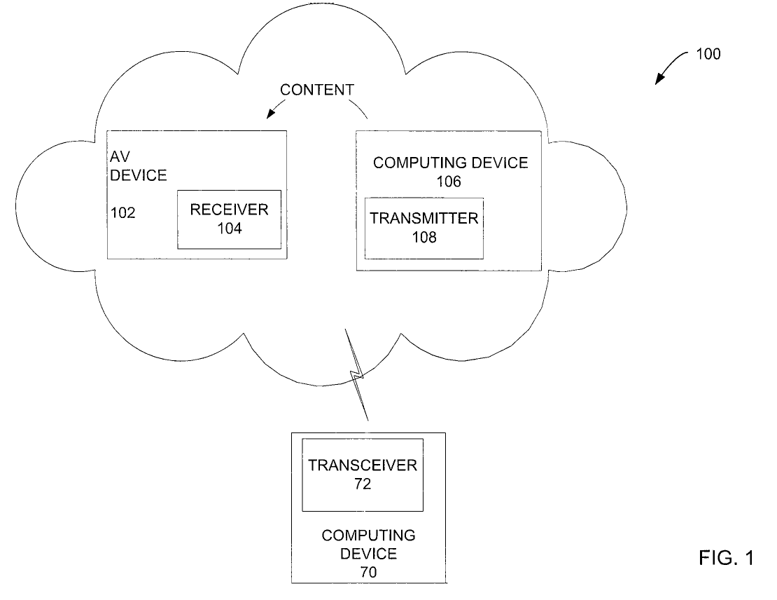

FIG. 1 is a diagram of an embodiment of a wireless network 100. The wireless network 100 includes Audio/Visual (AV) device 102 having a wireless receiver 104. The AV device 102 may be a digital TV or other display device. The receiver 104 may be an ATSC receiver to receive content and other information according to the ATSC standard. The wireless network 100 further includes a computing device 106 which may be a PC or other local computing device. The computing device 106 further includes a transmitter 108 for wireless communication with AV device 102. The receiver 104 of AV device 102 and the transmitter 108 of computing device 106 may each be a transceiver, capable of two way communications, but are illustrated according to their function used in the present embodiment to implement a secure pairing.

The wireless network 100 operates on short-range signals, such as Wi-Fi or Bluetooth, as part of a WLAN. The AV device 102 and the computing device 106 may transmit and receive messages by means of radio frequencies (RF). An RF transmitter may impress digital data onto an RF frequency for transmission of the data by electromagnetic radiation. The RF transmitter may, for instance, modulate a carrier wave. An RF receiver may receive electromagnetic energy at an RF frequency and extract the digital data. The RF receiver may, for example, demodulate the received radio waves.

Messages sent across network 100 may be referred to as network traffic. The network traffic is provided as packets of content sent from the computing device 106 to the AV device 102. In one scenario, the AV device is an HDTV and the computing device 106 is a laptop computer, wherein a user loads video content, such as a movie, onto the computing device 106 for viewing on the larger TV screen of the AV device 102. Other scenarios are considered as well.

As illustrated in FIG. 1, a third party, such as a computing device 70 or wireless device located outside of the wireless network 100. The third party may use the transceiver 72 in attempts to intercept communications with the wireless network 100, such as to capture the content transmission from computing device 106 to the AV device 102. Such a situation is referred to as a threat model, wherein hackers attempt to “sniff” the wireless channel to obtain digital content transferred from a PC to a TV. This unauthorized access to HD content results in lost revenue to the producers, such as the music or television studios. Therefore, using an example embodiment, an authorized purchaser of such content is able to view and experience the content on a variety of devices without loss of revenue to the producer.

While users of devices within a short range wireless network, such as used with ATSC devices, desire ease of use and transfer of content, both users and content providers consider privacy and security important for wireless transmissions, and seek to prevent third parties outside the wireless network from obtaining digital content, such as the plaintext or plain-images of the video content, without proper consent. Such sniffing by a third party is possible when the short-range transmitter and a typical DTV receiver are used, as an off-the-shelf wireless receiver may be able to spy on the digital content broadcasts. Such a malicious attack against a wireless TV to computing device pairing violates the privacy of legitimate users as well as the copyrights held by content providers.

### Devices

In an example embodiment, a peripheral card is plugged into a computing device, the peripheral card having a short-range ATSC transmitter to enable transmission of digital content to a display device or DTV. The digital content, such as video content, in the computing device can be transmitted wirelessly, or broadcast, in an encrypted format on an ATSC channel to the nearby DTV or other display device. To receive and play the digital content, a firmware update is provided to the DTV to enable processing of the encrypted content. Such a system enables additional security features which are not currently part of terrestrial broadcasts. The security features enable a secure one-to-one binding between the computing device and a digital display device, such as an HDTV.

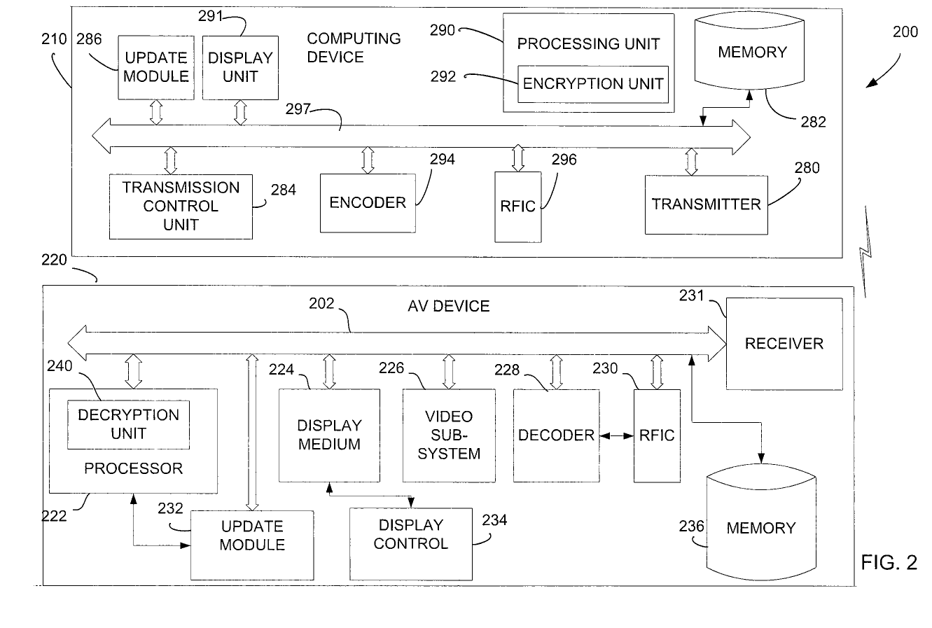

The following discussion describes an example embodiment of a wireless system including a processing device and a display device. FIG. 2 illustrates a wireless network 200, such as a local network in a home or office, having a plurality of computing devices with wireless capability. In this scenario, a computing device 210 communicates with a digital AV device 220 via an over-the-air connection. The computing device 210 includes a transceiver 280, which includes a transmitter and receiver for communicating within the wireless network 200. The computing device may also have additional communication capabilities, such as a cellular interface or other networking capability for receiving digital content, including audio and video digital content such as movies and musical works. The computing device 210 includes a memory 282, which is a memory storage device and may be used as a database. A processing unit 290 controls operations within the computing device 210, including control of wireless communications through a transmission control unit 284 and implementation of updates to operating code and content through an update module 286. The computing device 210 further includes an RF module 296 and an encoder module 294. The various modules within the computing device 210 communicate via a communication bus 297. Direct connections may also be used between individual modules. FIG. 2 further includes a display unit 291 for displays of image and so forth at the computing device 210.

In operations with respect to digital content, the computing device 210 receives digital content, which is then stored in memory 282. The digital content may be received from a Compact Disc (CD), a Digital Video Disc (DVD), a portable memory device, or from a wireless communication. The digital content may then be available for presentation on the computing device 210. In some scenarios, the computing device 210 includes a display device, such as a monitor or display screen, and in other scenarios, the computing device outputs the digital content to a monitor or display device attached to the computing device 210. In still other scenarios, the computing device 210 transmits the digital content to an AV device for presentation. In some scenarios, the computing device 210 streams the digital content to a display device for presentation, such as a real-time presentation.

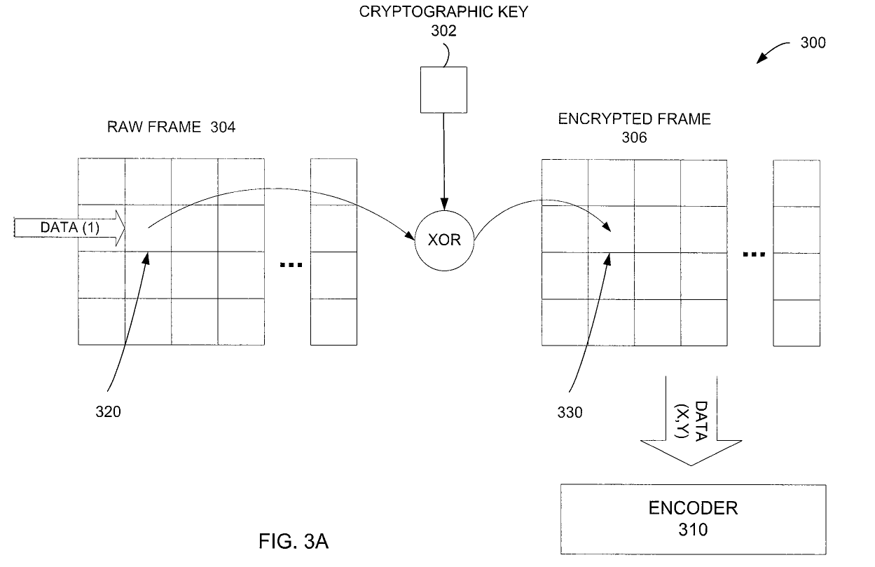

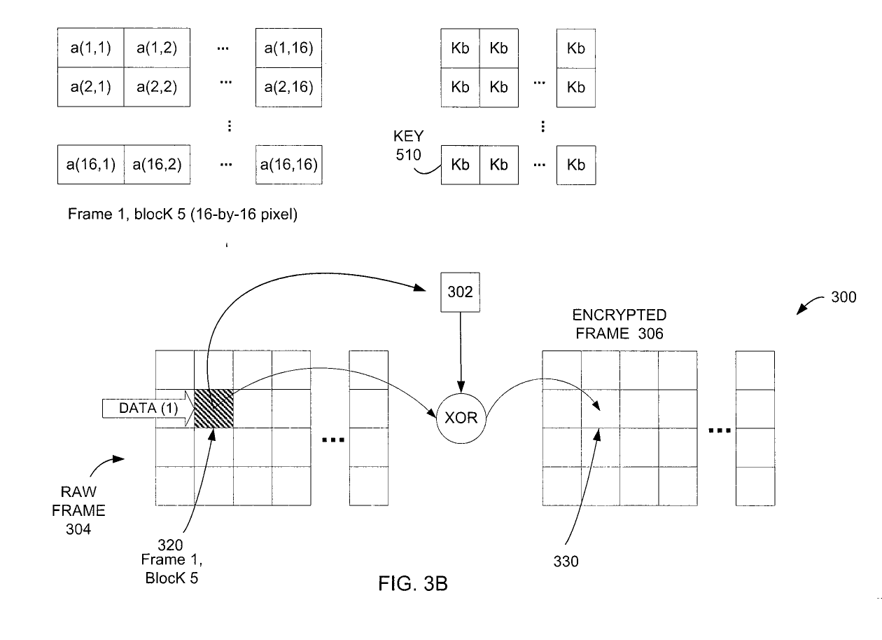

The computing device 210 includes a transceiver 280 which is controlled by the processing unit 290 through a transmission control unit 284. The transmission control unit 284 may select a type of wireless communication, and determine the specifics of such a transmission, including encryption, coding, data rate and other specifics to satisfy Quality of Service (QoS) criteria. The processing unit 290 further includes an encryption unit 292 to encrypt digital content. Various encryption techniques are discussed with respect to FIG. 3A and others.

Still further, the computing device 210 includes an update module 286 which implements updates and bug fixes within the computing device 210. The update module 286 may be used to implement updates to the transceiver 280, transmission control unit 284 and processing unit 290. The update module 286 transforms the code, including but not limited to software and firmware, in the memory 282 and the processing unit 290 into updated code. Thus enabling the computing device to implement the updated functionality. The update module 286 transforms code in the transceiver 280 and the transmission control unit 284 into updated code to implement updated functionality. In an example embodiment, the update module 286 transforms the code in the transceiver 280 and the transmission control unit 284 into ATSC enabling code, such that the transceiver 280 is enabled to transmit digital content as ATSC content. Similarly, once updated, the transceiver 280 and the transmission control unit 284 transform digital content into ATSC content for transmission within wireless network 200.

The computing device 210 communicates wirelessly with the AV device 220. In an example embodiment the AV device 220 is a HDTV, but other display devices may be used. The AV device 220 is capable to process digital content, including video and audio content, having a display medium 224 and a display control 234. The AV device 220 further includes a processor 222 to control operations within the AV device 220, sending and receiving commands and information via a communication bus 202 as well as via other connections (not shown) to modules within the AV device 220. The processor 222 is operable to execute instructions and control information. In some embodiments, the processor 222 executes computer-readable code, including but not limited to, software and firmware to perform functions on circuitry within the AV device 220. The computer-readable code may be stored within the processor 222, or in a memory 236 or other memory storage device (not shown). The computer-readable code may be updated through an update module 232. Updates may be received at the AV device 220 from uploaded information, such as from a portable memory device, or may be received via a wireless communication. The update module 232 operates to implement the updates, which allow the AV device 220 to adapt to updates and bug fixes applicable to the AV device 220. Additionally, the update module 232 may implement updates to the display control 234 for control of the display medium 224, as well as for the receiver 231, decoder 228 and video subsystem 226.

As illustrated in FIG. 2, a display medium 224 is included within the AV device 220, which may be a display screen or TV screen. In some embodiments, the display medium 224 is external to the AV device 220. The AV device 220 includes a video subsystem 226, a decoder 228, a Radio Frequency Integrated Circuit (RFIC) 230, and a receiver 231. The various units may be coupled directly or may communicate through the communication bus 202.

The digital content, and other information, is received via the receiver 231 as modulated waveform and is then processed in the RFIC 230 to retrieve the encoded digital content. The RFIC 230 passes the encoded digital content to the decoder 228, which may be an MPEG or other decoder. In an example embodiment, the decoder 228 is an MPEG2 decoder implemented in Application Specific Integrated Circuit (ASIC) or other circuitry, which may be directly coupled with the RFIC 230. The RFIC 230 may include an ATSC receiver to process content transmitted from the transceiver 280 in the computing device 210. The ATSC communications are commonly used for transmission of content to an HDTV; however, other communications may be implemented, wherein the transceiver 280 and the receiver 231 may be updated to comply with any of a variety of communication protocols.

Within the processor 222 of the AV device 220 is a decryption unit 240, which may alternatively be located elsewhere within the AV device 220. The decryption unit 240 enables the AV device 220 to process the ATSC information in coordination with decoder 228. For example, when a traditional DTV receives an encrypted video stream, such as encrypted MPEG2 transmissions, the traditional DTV attempts to decrypt the video stream using a cryptographic algorithm, such as according to the Advanced Encryption Standard (AES) or other specifications, but the traditional DTV is not able to process the stream correctly as the current ASTC standards do not provide a circuit for decryption. To enable such decryption capability would typically involve modification of the circuitry of the traditional DTV. Additionally, the management functions provided in a traditional DTV are not able to process the cryptographic encryption for content such as a stream of high volume video data. As an example, an off-the-shelf 500 MHz Central Processing Unit (CPU) is able to perform approximately 500,000 AES block operations per second. The cryptographic budget for processing a frame of 1600×1600 pixels, wherein each pixel includes 32-bits and wherein the video streams, such as provided at 60 frames/sec, results in 3.84×107 operations each second. The cryptographic demand exceeds the available processing performance by a factor of close to 100.

### Encryption

FIG. 3A illustrates an encryption mechanism for communications within a wireless network, such as in FIG. 1, in accordance with example embodiments. As illustrated, the mechanism 300 applies a cryptographic key block 302 to the raw frame 304. The raw frame 304 of video data, wherein each raw frame 304 includes a plurality of blocks, each block defines a square of pixels, such as 16×16 pixels per block. Data is received as raw frame 304 wherein the mechanism 300 applies the cryptographic key block 302 to each block of the raw frame 304. The data in raw frame 304 is transformed into the encrypted frame 306 at a computing device. In an example embodiment, an exclusive OR function (XOR) is applied to each block of the raw frame 304 with the cryptographic key block 302 to form the encrypted frame 306. As illustrated the data(1) is received and identifies block 320 of the raw frame 304. In the present example, the block 320 is a 16×16 pixel block of digital data, but may be other sizes and configurations in other examples. The encrypted frame 306 has the same configuration as the raw frame 304, wherein each as a block is encrypted with the cryptographic key block 302, the resultant information makes up the encrypted frame 306. The data(1) of block 320 is encrypted and represented by block 330. The frame data of block 320 may result from signal processing and transformation of pixel data, such as by Discrete Cosine Transform (DCT) type processing, wherein coefficient values or numbers associated with such transformation are stored. The data may be encrypted, such as through an exclusive OR (XOR) operation with a key value. The encrypted data may then be provided to the encoder 310. The encryption mechanism 300 applies the cryptographic key block 302 to each block of the raw frame 304. The digital content information of the raw frame 304 and of the corresponding encrypted frame 306 may be stored in the memory 282 of the computing device 210 as arrays of data, wherein each block identifies a location within the raw frame 304 and the encrypted frame 306. Some embodiments may implement an alternative technique for encrypting the content, such as the use of other logical operations, or other functions.

The encryption mechanism is performed in the computing device 210, such as the encryption unit 292 of the processing unit 290. The encrypted information is then processed for transmission through the transceiver 280 to the AV device 220. Further processing within the computing device 210 encodes the encrypted digital content and prepares for RF transmission. Referring to FIG. 3B, sample processing according to an example embodiment is provided. As illustrated, in the raw frame 304, data (1) is provided to a block designated as block (5) 320. The process shares an initial secret key between a television and a computing device, such as through presentation of a pictorial pattern on a screen display or an audio output and using an underlying public key based handshake protocol. The pictorial pattern or audio output may be provided via an out-of-band channel. The process then applies the secret key, referred to as K, to generate the cryptographic key block 302, referred to as Kb, as is described in further detail below.

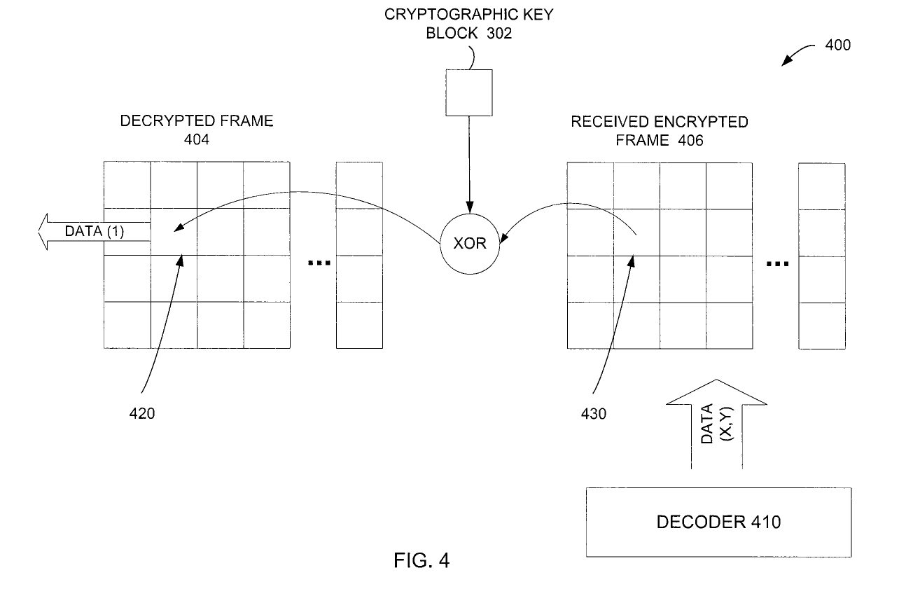

FIG. 4 illustrates the corresponding decryption of the information encrypted as in FIG. 3A and FIG. 3B. The decryption mechanism is for communications within a wireless network, and in particular decryption of received content. The mechanism 400 begins when the content is decoded in decoder 410, which may be decoder 228 of FIG. 2, wherein the decoded data corresponds to a received encrypted frame 406, in the same configuration as the encrypted frame 306. The mechanism 400 applies the cryptographic key block 302 to each block of the received encrypted frame 406. As illustrated, the received encrypted content is received as data(x,y), which includes the data for block 430. The block 430 is decrypted using the cryptographic key block 302 to provide decrypted content of block 420 of the decrypted frame 404. The decryption mechanism 400 transforms the encrypted data into decrypted data, which is then provided from block 420, for example, as data (1), or in the original form prior to encryption by the computing device 210. The cryptographic key block 302 is the same key as used in the encryption mechanism 300 of FIG. 3A, wherein a logical XOR function is applied to each block of the received encrypted frame 406 with the cryptographic key block 302 to generate the decrypted frame 404. The decryption mechanism 400 is performed by the decryption unit 240 of FIG. 2, and is provided to the video subsystem 226 to process the decrypted frame 404.

The encryption mechanism 300 of FIG. 3A and the decryption mechanism 400 are complementary to each other, wherein both share the cryptographic key block 302, meaning that both the computing device and the AV device use the same key. In an example embodiment, a user-friendly method is used to share a secret key to use to generate the cryptographic key block 302 which is shared between the computing device and the AV device.

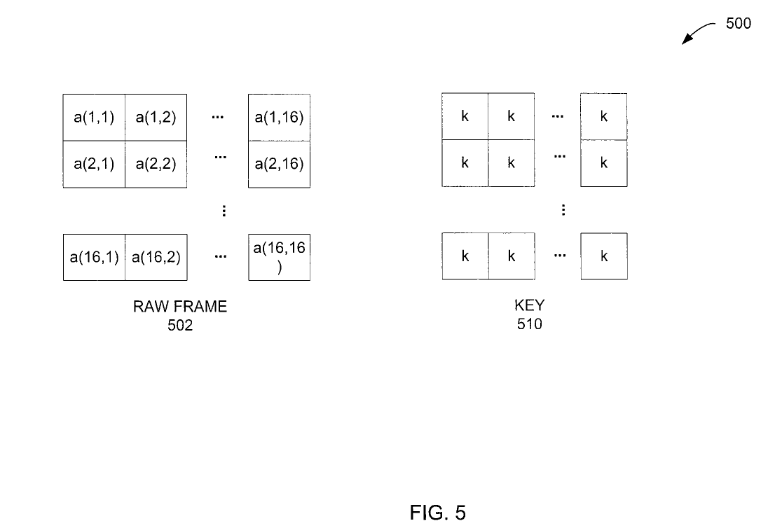

As illustrated in FIG. 5, the cryptographic key block 500 for a 16-by-16 pixel block of a video frame applies a secret key “k” to each block in the raw frame 502. The secret key k is a random value in the range (0, R), where R is the upper bound for the pixel value. For a 1600×1600 pixel frame, where each block of the frame uses a different k, the frame applies 10,000 such cryptographic key blocks. Some embodiments optimize key sharing over multiple blocks, which reduces the number of keys. As illustrated in FIG. 5, the key 510 includes a key for each block in the frame, each corresponding to a block of the raw frame 502. In the illustrated example, each block uses a same key k.

In some embodiments a method of a one-time pad is used to efficiently achieve a desired level of security. A one-time pad is to use some random, unpredictable bit stream to XOR the message to be transmitted. The resultant stream is cryptographically strong so as to defend against decipher by an unauthorized user. As the public key operations are not performed frequently, a key derivation may be a function of the number of blocks per frame, such as according to:

Block_key<----AES(k,frame_number∥block_number) (1)

wherein k is obtained through an out of band channel, and wherein denotes a concatenation operation. The block key (Block_key) is used to encrypt the raw blocks of the raw frame data, such as by an exclusive OR (XOR) operation.

As illustrated in FIG. 3B, Equation (1) is applied to the block 320, frame (1) and block (5), by applying the secret key K to generate a key block. Specifically, the example of FIG. 3B generates Kb according to:

Kb<----AES(k,frame(1)∥block(5)), (2)

wherein the process truncates the value of Kb so as to be in the same value range of each pixel value for the raw frame 304. Equ, (2) is substantially similar to Equ. (1) for a specific case where frame identification is as described in FIG. 3B. Note, the frame and block designations or indices may be assigned in a variety of manners and are only given for clarity of understanding in this illustration. To process the raw frame 304 further, each block of the raw frame 304 is exclusive ORed (XORed) with Kb. In some examples, the pixel values of the raw frame 304 are XORed with Kb to form the encrypted frame 306. As illustrated, the raw frame 304 includes a plurality of individual blocks, each having identifiers a(i,j), where the first index, i, corresponds to a row of a frame, and the second index, j, corresponds to a column of a frame. For raw frame 304, encryption of a(i,j) is performed as:

a_{raw}(i,j) XOR Kb=>a_{encrypted}(i,j). (3)

The operation of Equ. (3) is repeated for each block of raw frame 304. In the example of FIG. 3B, the key block 302 is made up of multiple blocks each assigned a same value of Kb 510. Some embodiments may implement different values for multiple blocks of the key block 302. The encrypted block 330 is then stored as encrypted frame 306. A variety of other techniques may be implemented to encrypt raw data, wherein the secret key is provided from a display or output of the television or other display device, received at the computing device either automatically or by a user, and wherein the secret key is used with a public key to encrypt content and transmit the content from the computing device to the television or other display device. The television is then able to decrypt the key information using the private key to retrieve a session key, and then use the session key to decrypt the programming content.

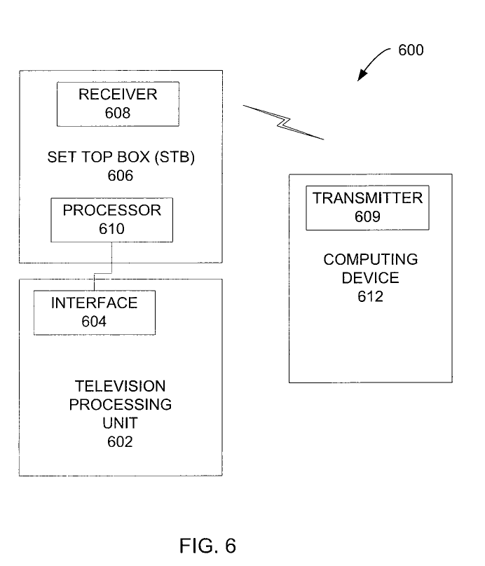

FIG. 6 is a block diagram of a wireless network 600 having a computing device 610 and television processing unit 602. The television processing unit 602 includes an interface 604 incorporating an encryption mechanism. The wireless network 600 includes a set top box 606 configured proximate the television processing unit 602, wherein the interface 604 communicates with a processor 610. The set top box 606 further includes a receiver 608 for communication with the transmitter 609 of the computing device 612. The transmitter 609 is an ATSC transceiver and transmits content to the set top box 606. In some embodiments the television is able to negotiate the keys, receive the encrypted content, decrypt the keys and content, and enable display of the decrypted content, wherein the computing device may transmit content directly to the television without use of a set top box.

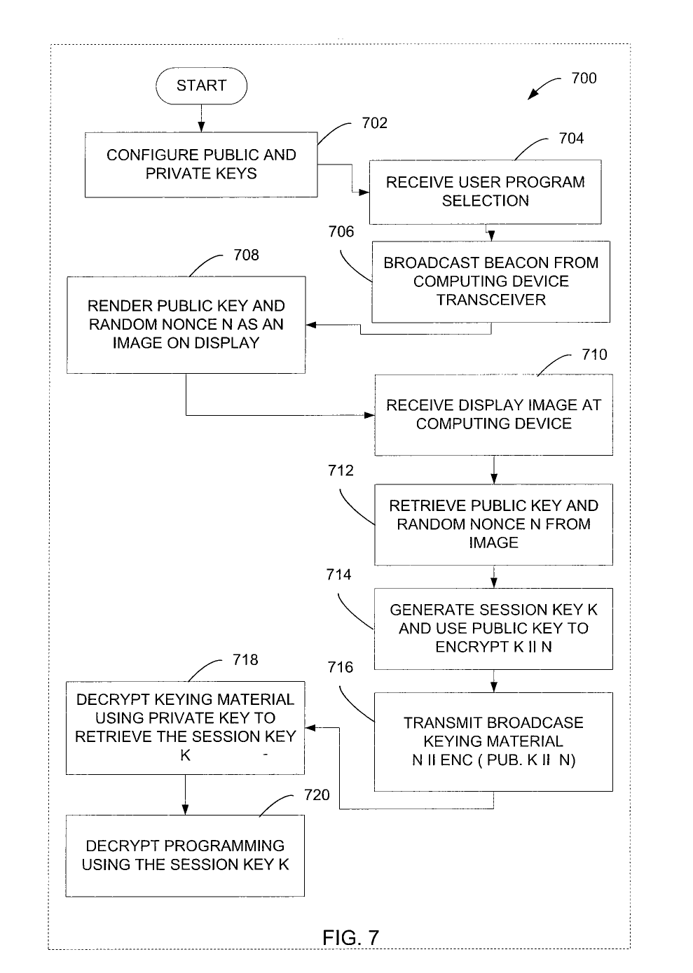

FIG. 7 is a flow diagram of an example method 700 for operation in the wireless network 600 of FIG. 6. The method 700 is an out-of-band method using a shared key between the computing device 610 and the set top box 606 or a DTV. The method 700 starts at the set top box 606 by configuring public and private keys, operation 702. A user inputs a selection at the computing device 610, receives the user program selection, operation 704, and broadcasts a beacon from the computing device receiver 608, or a transmitter, operation 706. The set top box 606 receives the beacon, and renders a public key and a random nonce N as an image on the television processing unit 602, operation 708. The computing device 612 includes a mechanism to capture the image displayed on the television processing unit 602. In one embodiment, the mechanism is a camera or other device for image capture and analysis. The computing device 612 receives the display image, operation 710, and retrieves the public key and random nonce N from the image, operation 712. The computing device 612 generates a session key k and uses the public key to encrypt k concatenated with N, operation 714. The computing device 612 then transmits the keying material including N concatenated with a concatenation of the public key and N, operation 716. The set top box 606 decrypts the keying material using a private key and retrieves the session key k, operation 618. The set top box 606 then decrypts the programming content using the session key k, operation 620.

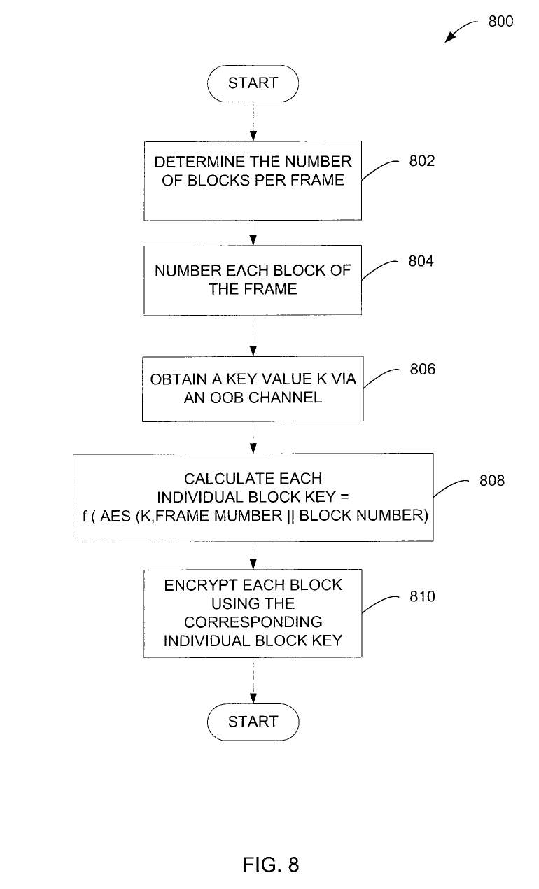

FIG. 8 illustrates an embodiment for implementing a secure pairing between a DTV and a computing device. As illustrated, the computing device determines a number of blocks per frame of content data, operation 802. The computing device assigns a number to each block of the frame, operation 804, and obtains a key value k via an out-of-bound channel, operation 806. The computing device then calculates each individual block key as in Equ. (1) using an AES encryption technique, operation 808. The method 800 includes operations to encrypt each block using the corresponding individual block key, operation 810.

Some embodiments are applicable to a short-range ATSC transmitter to broadcast secure content or display information wirelessly to an ATSC receiver, such as in a traditional HDTVs. Such embodiments are backward compatible with traditional or legacy DTVs and HDTVs. As ATSC is the standard wireless interface of traditional DTVs and HDTVs, implementation of a firmware update to the television provides security at a level similar to an HDMI wired connection.

An example embodiment provides inner and outer encrypting, which is applicable to the embedded microprocessors of HDTVs, enabling the secure wireless display functionality using a firmware upgrade. The encrypting method uses an out-of-band channel to share a key block between a computing device and a legacy TV. Further, the method may be use to spawn keys for the granularity of the key blocks for the video encryption. The number of keys may be designed to depend on the number of blocks, as indicated in Equ. (1). As the number of block increases, the size of each block decreases, thus resulting in a finer granularity of the key blocks.

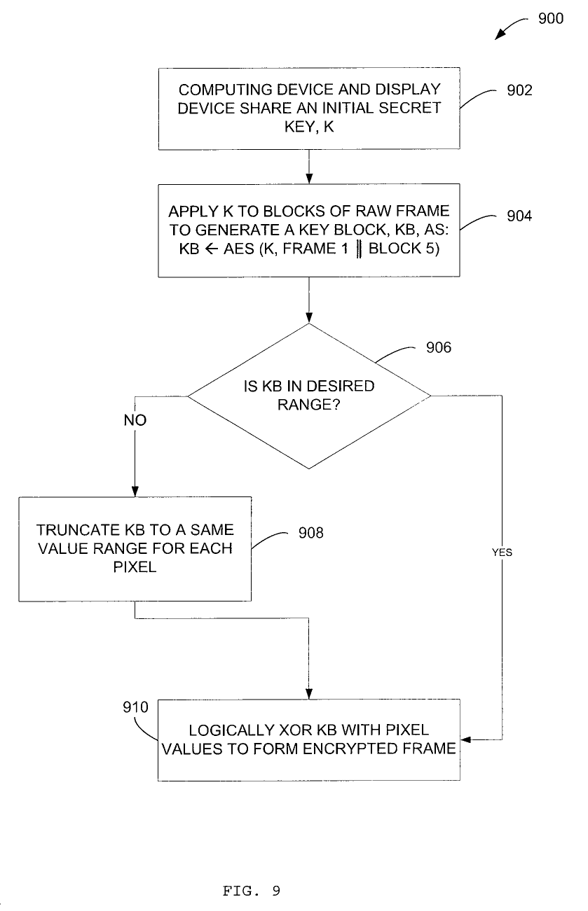

FIG. 9 illustrates an encryption method 900 according to an example embodiment, wherein the computing device and display device share an initial secret key, designated as K, at operation 902. The secret key may be transmitted between the devices, or may be displayed on a display screen for a user to identify and enter into the other device. There are a variety of methods for sharing the key. The secret key, K, is then applied to blocks of raw frame data, operation 904, to generate a key block, designated as KB. In one example, the value of the key block, KB is given as:

KB←AES(K,FRAME 1∥BLOCK 5). Equ. (2)

The process then determines if the calculated value of KB is within a desired range of values, decision point 906. When the value of KB is outside a desired range of values, then the value KB is truncated at operation 908. The process then performs a logical XOR operation of the key block, KB, with the pixel values of each block to form an encrypted frame, operation 910.

In some embodiments, a machine-readable medium is comprised of instructions, which when implemented by one or more machines, cause the one or more machines to receive a registration request from a service provider, store a set of information for the service provider in a memory storage unit, and transmit an indication of the service provider to at least one service consumer in the wireless communication network.

Unless specifically stated otherwise, terms such as “processing,” “computing,” “calculating,” “determining,” “displaying,” or the like, may refer to an action and/or process of one or more processing or computing systems or similar devices that may manipulate and transform data represented as physical (e.g., electronic) quantities within a processing system's registers and memory into other data similarly represented as physical quantities within the processing system's registers or memories, or other such information storage, transmission or display devices. Furthermore, as used herein, a computing device includes one or more processing elements coupled with computer-readable memory that may be volatile or non-volatile memory or a combination thereof.

Embodiments may be implemented in one or a combination of hardware, firmware, and software. Embodiments may also be implemented as instructions stored on a machine-readable medium, which may be read and executed by at least one processor to perform the operations described herein. A machine-readable medium may include any mechanism for storing or transmitting information in a form readable by a machine (e.g., a computer). A machine-readable medium may include, but is not limited to, FLASH memory, optical disks, Compact Disks-Read Only Memory (CD-ROM), Digital Versatile/Video Disks (DVD), Read Only Memory (ROM), Random Access Memory (RAM), EPROM, Electrically Erasable Programmable Read-Only Memory (EEPROM), magnetic or optical cards, propagation media or other type of machine-readable media suitable for storing electronic instructions. For example, embodiments may be downloaded as a computer program, which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with at least one embodiment. Therefore, it should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments.

Similarly, it should be appreciated that in the foregoing description of embodiments, various features are sometimes grouped together in a single embodiment, figure, or description thereof for the purpose of streamlining the disclosure, aiding in the understanding of one or more of the various inventive aspects. This method of disclosure, however, is not to be interpreted as reflecting an intention that the claimed subject matter requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Having disclosed embodiments and the best mode, modifications and variations may be made to the disclosed embodiments while remaining within the scope of the embodiments as defined by the following claims.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method for a computing device, comprising:
receiving digital content;
determining a cryptographic key for encrypting a raw data frame of the digital content;
encrypting the raw data frame with the cryptographic key to form an encrypted frame;
providing the cryptographic key to a display device; and
transmitting the encrypted frame to the display device via a wireless channel using an Advanced Television Systems Committee (ATSC) protocol.

2. The method of claim 1, further comprising:
establishing a short range transmission channel with the display device; and
transmitting the encrypted frame to the display device over the short range transmission channel.

3. The method of claim 2, wherein the display device is a Digital Television (DTV) having an ATSC receiver, wherein the computing device includes a short-range ATSC transmitter, and wherein establishing a short range transmission channel comprises establishing an ATSC communication between the computing device and the display device.

4. The method of claim 3, wherein the cryptographic key is a symmetric cryptographic key, and wherein:
determining a cryptographic key comprises capturing an image of a public key presented by the display device; and
transmitting the encrypted frame to the display device comprises transmitting the encrypted frame from the ATSC transmitter of the computing device so as to be received by the ATSC receiver at the display device.

5. The method as in claim 4, further comprising:
encrypting a secret key with the public key to generate an encrypted secret key; and
transmitting the encrypted secret key to the display device so as to enable the display device and the computing device to share the secret key.

6. The method of claim 5, wherein encrypting the raw data frame with the cryptographic key comprises performing a logical exclusive OR (XOR) operation of a block of the raw data frame with the cryptographic key to form an encrypted block of the raw data frame within an encrypted frame.

7. The method of claim 3, wherein determining the cryptographic key comprises receiving an audio signal from the display device, the audio signal identifying a public key, and wherein the method further comprising:
reconstructing the public key from the audio signal;
encrypting a secret key with the public key to generate an encrypted secret key; and
transmitting the encrypted secret key to the display device so as to enable the display device and the computing device to share the secret key.

8. A method for receiving digital content at a display device, comprising:
presenting a public key by the display device;
receiving digital content from a computing device over a wireless channel, the digital content including an encrypted data frame via a wireless channel as an Advanced Television Systems Committee (ATSC) protocol transmission;
receiving a cryptographic key using the public key, the cryptographic key for decrypting the encrypted data frame of the digital content;
decrypting the encrypted data frame with the cryptographic key to retrieve a decrypted data frame of the digital content; and
displaying the digital content on the display device.

9. The method of claim 8, further comprising:
receiving an update packet of data specifying operating instructions;
installing the update packet of data at the display device; and
operating the display device to include operations included in the update packet of data.

10. The method of claim 8, wherein the display device includes a Digital Television (DTV) and the operations add security processing to the DTV, wherein the operations are to:
enable the display device to receive the cryptographic key; and
perform operations to decrypt the encrypted data frame with the cryptographic key.

11. The method of claim 10, wherein the display device has a short-range Advanced Television Systems Committee (ATSC) receiver and the computing device includes an ATSC transmitter, and wherein establishing a short range transmission channel comprises:
establishing an ATSC communication between the computing device and the display device, and
wherein the method further comprising:
receiving a secret key from the computing device, the secret key encrypted with the public key;
receiving an encrypted frame of content at the ATSC receiver of the display device; and
decrypting the encrypted frame of content to retrieve the digital content for display at the display device.

12. The method of claim 11, wherein:
presenting the public key comprises displaying an image on the display device or outputting an audio signal from the display device corresponding to the public key.

13. A display apparatus, comprising:
a receiver supporting a short range wireless communication protocol; and
a memory to store digital content and information for processing the digital content for display on the display apparatus, the memory comprising:
a decryption unit to apply a cryptographic key to encrypted digital content to transform the encrypted digital content into decrypted digital content, wherein the encrypted digital content is received at receiver; and
a display controller to control display of the decrypted digital content.

14. The display apparatus as in claim 13, wherein the encrypted digital content is encoded, the display apparatus further comprising:
a decoder to transform the encrypted digital content into decoded encrypted digital content and to provide the decoded encrypted digital content to the decryption unit.

15. The display apparatus as in claim 14, wherein the display apparatus is a Digital Television (DTV), the short range wireless communication protocol is an Advanced Television Systems Committee (ATSC) protocol.

16. The display apparatus as in claim 15, wherein the display controller is further to display a public key, wherein the receiver is further to receive a shared secret key from a computing device, the shared secret key encrypted with the public key, and wherein the shared secret key is used to generate the cryptographic key.

17. The display apparatus as in claim 16, wherein the computing device includes an encryption unit to encrypt digital content using the cryptographic key, and a transmitter to transmit encrypted digital content to the display device using the ATSC protocol via a wireless channel, and a memory to store information related to the digital content and the cryptographic key.

18. The display device of claim 17, wherein the encryption unit of the computing device is further to determine the cryptographic key as a random value, and the transmitter is to transmit the cryptographic key to the display device using the ATSC protocol.

19. The display device of claim 18 wherein the computing device further comprises an encoder to encode the encrypted digital content, and wherein the transmitter is to transmit the encoded encrypted digital content.

20. The display device of claim 19, where the computing system further comprises an update module to provide update information to the display device.
